(19) United States
(12) Patent Application Publication
(10) Pub. No.: US 2017/0086394 A1
(43) Pub. Date: Mar. 30, 2017

(54) CUT TREE INFORMATION SYSTEM

(71) Applicant: Deere & Company, Moline, IL (US)

(72) Inventor: Bryon P. Neumann, Brantford (CA)

(21) Appl. No.: 15/282,228

(22) Filed: Sep. 30, 2016

Related U.S. Application Data
(60) Provisional application No. 62/235,448, filed on Sep. 30, 2015.

(51) Int. Cl. A01G 23/08; G01C 21/34; H04W 4/02

(52) U.S. Cl. CPC A01G 23/08; H04W 4/023; G01C 21/34

(57) ABSTRACT

A logging information system includes a felling machine that includes a first global positioning system receiver and a sensor configured to measure an orientation of a felling head operably connected to the felling machine, and an information system controller operable to estimate a cut tree location based on a measured global position of the felling machine and a measured orientation of the felling head of the felling machine.

### CROSS-REFERENCE TO RELATED APPLICATIONS

This application claims priority to U.S. Provisional Patent Application No. 62/235,448, filed on Sep. 30, 2015, and entitled Cut Tree Information System, the entire content of which is hereby incorporated by reference in its entirety.

### BACKGROUND

The present disclosure relates to systems and methods for felling trees, in particular with a forestry vehicle. More specifically, the present disclosure relates to a system that improves tree cutting and removal efficiency during a logging operation.

Logging generally involves cutting down trees (tree felling), removing the cut down trees (skidding), and then transporting the cut down trees. Tree felling can be performed by hand (i.e., using an axe, saw, chainsaw, or other handheld device) or with mechanical assistance (i.e., using one or more pieces of logging equipment). A tree feller-buncher is a motorized mechanical felling vehicle that carries an attachment that cuts and gathers one or more trees during the process of tree felling. After a tree is felled, the tree feller-buncher positions the felled trees into one or more piles. A skidder or forwarder, which is a motorized vehicle that move the cut down trees to a location for transport, moves the piled felled trees to a location for transport. Due to the number of vehicles involved in logging and the variability in diameter, height, and weight of trees, there exists opportunities to improve logging efficiency.

### SUMMARY

In one aspect, the disclosure provides a cut tree information system to improve logging efficiency. The system utilizes information from a tree feller-buncher and a tree forwarder to improve logging efficiency. More specifically, the cut tree information system optimizes a felled tree pile size, such that the tree forwarder will not require excessive return trips to transport each felled tree pile. The cut tree information system also identifies and tracks locations of each felled tree pile, communicates the locations to the tree forwarder, and calculates an optimized path to each felled tree pile based on the location of the tree forwarder.

In another aspect, the disclosure provides a logging information system. The system includes a felling machine that includes a first global positioning system receiver and a sensor configured to measure an orientation of a felling head operably connected to the felling machine, and an information system controller operable to estimate a cut tree location based on a measured global position of the felling machine and a measured orientation of the felling head of the felling machine.

Other aspects of the disclosure will become apparent by consideration of the detailed description and accompanying drawings.

### BRIEF DESCRIPTION OF THE DRAWINGS

FIG. 1 is a side view of a non-leveling tracked tree feller-buncher.

FIG. 2 is a side view of a leveling tracked tree feller-buncher.

FIG. 3 is a partially schematic side view of a tree forwarder.

FIG. 4 is a schematic layout of the tree feller-bunchers of FIGS. 1 and 2 illustrating sensor positioning for acquiring data during operation of the tree feller-bunchers.

FIG. 5 is a flow diagram of an embodiment of a cut tree information system for improving logging operation efficiency.

### DETAILED DESCRIPTION

Before embodiments of the disclosure are explained in detail, it is to be understood that the disclosure is not limited in its application to the details of construction and the arrangement of components set forth in the following description or illustrated in the accompanying drawings. The disclosure is capable of supporting other embodiments and of being practiced or of being carried out in various ways.

The term calculating (or calculate and calculated), as used herein, is used with reference to calculations performed by the disclosed system. The term includes calculating, determining, and estimating.

Also, various embodiments of the systems and methods herein are disclosed as being applied on or used in conjunction with tree feller-bunchers. As used herein an in the appended claims, the term “feller-buncher” encompasses tree fellers, feller-bunchers, harvesters, and any similar machine or device adapted to move or transport cut trees. In some embodiments, the systems and methods disclosed herein are particularly well-suited for application on or use in conjunction with equipment having one or more blades used to cut trees.

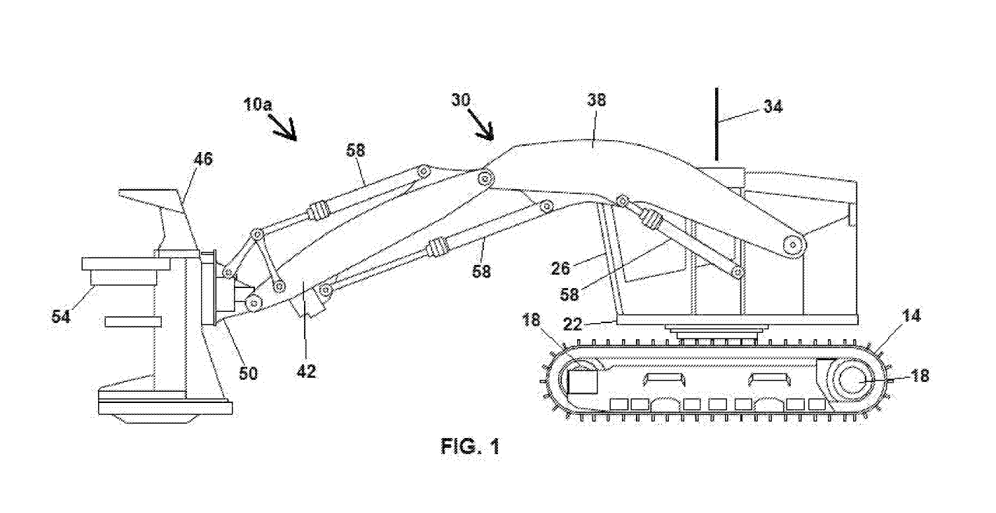

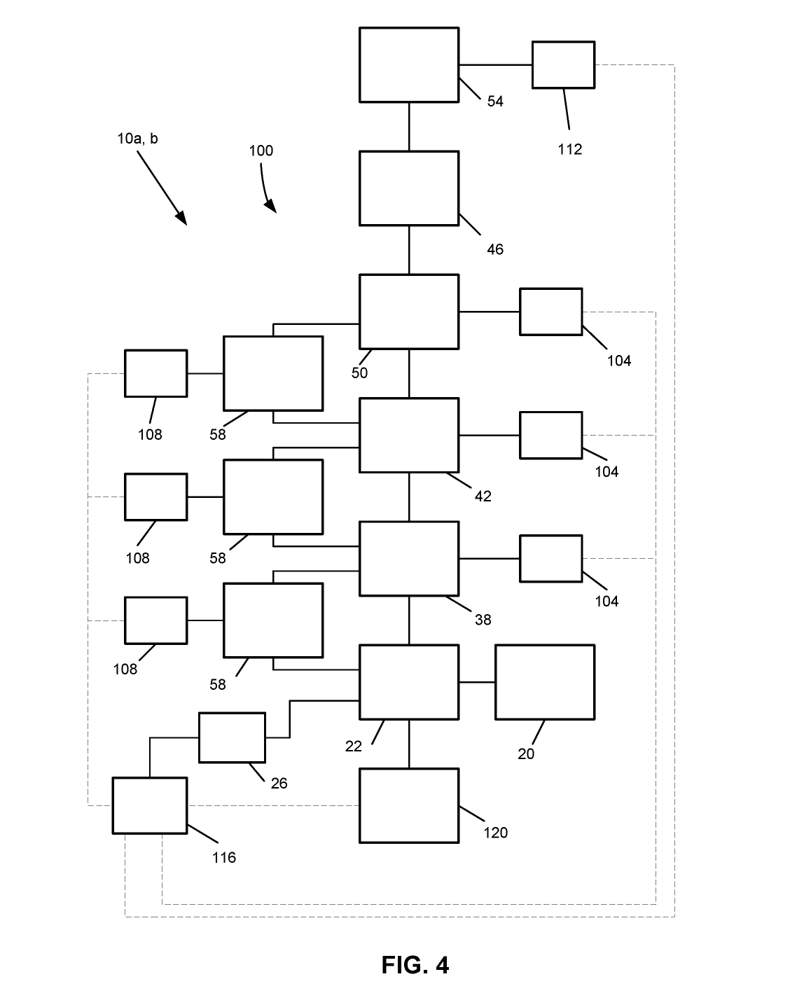

FIG. 1 illustrates an embodiment of a non-leveling tree feller-buncher 10a. The tree feller-buncher 10a includes a plurality of tracks 14 that are connected to an undercarriage or frame 20 (shown in FIG. 4). Each track 14 includes drive wheels 18 that rotate about an axle (not shown) carried by the undercarriage 20 to rotate the track 14. The undercarriage 20 is attached to a turntable 22 presenting a face that carries a cab 26 and a boom 30. The turntable 22 rotates about a first axis 34, allowing the turntable 22 (and attached cab 26 and boom 30) to rotate about, and independent of, the undercarriage 20 and attached tracks 14. In the illustration, the axis 34 is approximately perpendicular to the face of the turntable 22. However, in other constructions the axis 34 may be positioned at any suitable orientation to one or more components of the tree feller-buncher 10a to facilitate rotation of the turntable 22 about the undercarriage 20 (and the tracks 14). The turntable 22 rotates about the axis 34 three hundred and sixty degrees (360°). However, in other constructions the turntable 22 can rotate about the axis 34 less than three hundred and sixty degrees (360°). The cab 26 houses controls and an operator for operation of the tree feller-buncher 10a.

The boom 30 is pivotably connected to the turntable 22 and includes a plurality of sub-booms that define an articulated arm. The boom 30 includes a main boom or first boom 38 coupled to the turntable 22. A stick boom or second boom 42 is pivotably connected to the main boom 38. The stick boom 42 is also pivotably connected to a felling head 46 by a wrist adapter 50. The wrist adapter 50 facilitates both pivotable movement and rotational movement of the felling head 46 in relation to the stick boom 42. The felling head 46 includes a plurality of arms 54 that pivot about the felling head 46 to grab, retain, and release one or more trees during the felling and bunching process. A plurality of hydraulic cylinders 58 are positioned between the turntable 22 and the main boom 38, between the main boom 38 and the stick boom 42, and between the stick boom 42 and the wrist adapter 50. The hydraulic cylinders 58 are operable to move the respective main boom 38, stick boom 42, and wrist adapter 50. Additional hydraulic connections (not shown) facilitate movement of the felling head 54.

The tree feller-buncher 10a is non-leveling in that the orientation of the turntable 22 is dependent on the orientation of the undercarriage 20 (shown in FIG. 4) and the tracks 14. Stated another way, the turntable 22 cannot be repositioned independent of the undercarriage 20 and the tracks 14. Accordingly, the orientation of the turntable 22 (along with the attached cab 26 and the boom 30) is influenced by the ground or terrain encountered by the tracks 14.

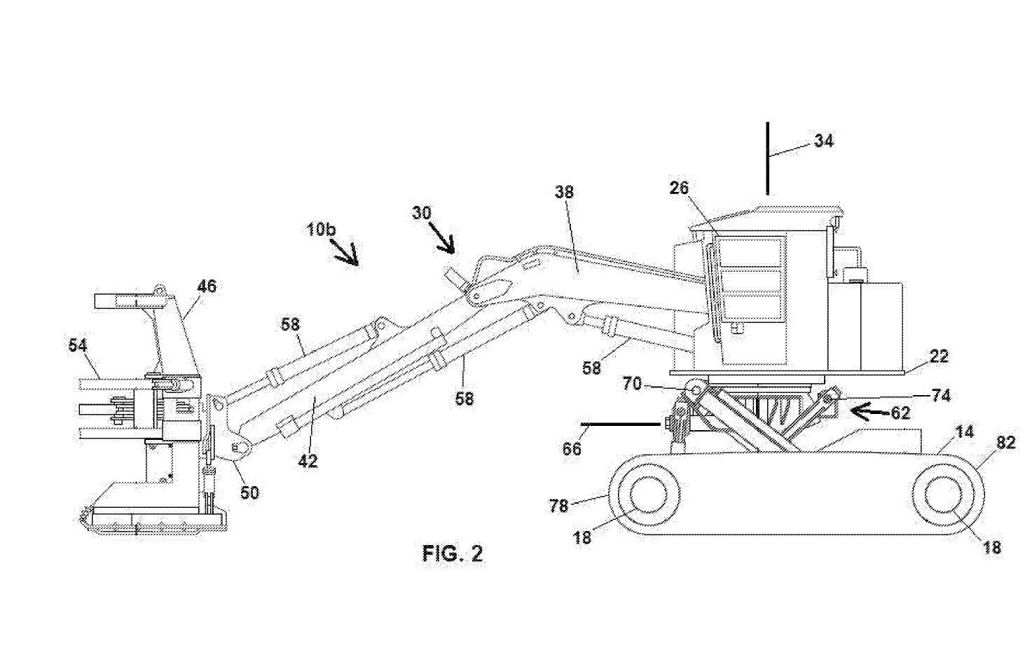

FIG. 2 illustrates an embodiment of a leveling tree feller-buncher 10b. The leveling tree feller-buncher 10b is substantially the same as the non-leveling tree feller-buncher 10a, with like numbers identifying like components. The leveling tree feller-buncher 10b further includes a leveling assembly 62 coupled to the turntable 22 and the undercarriage 20 (shown in FIG. 4). The leveling assembly 62 allows the operator to reposition the turntable 22 (along with the attached cab 26 and the boom 30) independently of the orientation of the undercarriage 20 and the tracks 14. Accordingly, the orientation of the turntable 22 (along with the attached cab 26 and the boom 30) is not necessarily influenced by the ground or terrain encountered by the tracks 14. The leveling assembly 62 allows for movement of the turntable 22 along the first axis 34 (moving the turntable 22 towards or away from the leveling assembly 62). In addition, the leveling assembly 62 can pivot side-to-side about a second axis 66 (moving the turntable 22 towards or away from each track 14). Further, the leveling assembly 62 can independently pivot about a third axis 70 and fourth axis 74, the third and fourth axes 70, 74 being approximately perpendicular to the second axis 66. The third and fourth axes 70, 74 facilitate angled positioning of the turntable 22 towards or away from a first end 78 of the track 14 (i.e., a “front” of the tree feller-buncher 10b as illustrated in the orientation of FIG. 2) or towards or away from a second end 82 of the track 14 (i.e., a “rear” of the tree feller-buncher 10b as illustrated in the orientation of FIG. 2).

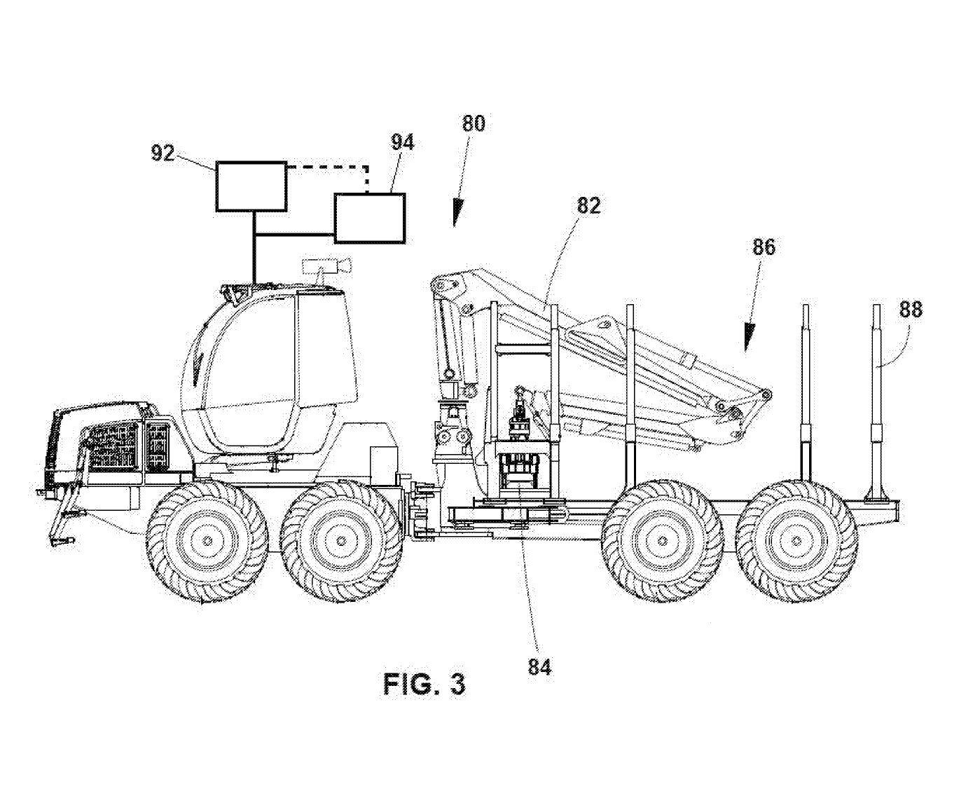

FIG. 3 illustrates an embodiment of a tree forwarder 80. The tree forwarder 80 is a motorized vehicle that moves felled trees, which are cut and piled by the tree feller-buncher 10a, 10b, to a location for transport. For example, the tree feller-buncher 10a, 10b cuts down a plurality of trees in a wooded area, and places them in a pile to facilitate removal. The tree forwarder 80 enters the wooded area and grasps the trees with an arm 82 having a grapple 84 (or grabber 84). The grasped trees can be positioned in a loading space 86 that can be partially defined by a plurality of posts 88. The tree forwarder 80 can then transport the trees out of the wooded area to a location for transport (such as to a semi-truck having a logging bed). Tree forwarders 80 can have different grapple 84 sizes. Stated otherwise, different grapples 84 can grasp different volumes of cut trees or pile sizes. Tree forwarders 80 can also have different loading space 86 sizes, meaning loading spaces 86 can contain different volumes of cut trees or piles. The tree forwarder 80 can also include a forwarder computer processing system or controller 92 and a Global Positioning System (GPS) receiver 94. The forwarder GPS receiver 94 can monitor the global location of the tree forwarder 80. The forwarder GPS receiver 94 can be in communication with the forwarder controller 92, illustrated in FIG. 3 by broken line. The communication can be wired, wireless, or any suitable system for communication (e.g., radio, cellular, BLUETOOTH, etc.). The forwarder controller 92 can also be in communication with a cut tree information system 200, which is discussed in additional detail below. The communication can be any suitable wireless system for communication (e.g., radio, cellular, BLUETOOTH, 802.11 Wireless Networking protocol, etc.). In other embodiments, the cut tree information system 200 can reside on and/or operate from the forwarder controller 92. The forwarder controller 92 is also in communication with an operator of the tree forwarder 80 through an operator interface (not shown) to present and/or receive information associated with the cut tree information system 200.

It should be appreciated that while the disclosure herein refers to a tree forwarder 80, as illustrated in FIG. 3, the disclosure is not limited to a tree forwarder, as the tree forwarder is provided for purposes of illustration. The system disclosed herein can operate in association with any suitable tree transport machine or tree removal and/or transport equipment. For purposes of the disclosure and associated claims, the term “tree transport machine” can include any suitable machine that transports trees from a location of felling (e.g., in a wooded area, woods, etc.) to a location of shipping (e.g., to a truck loading location, etc.). Accordingly, a tree transport machine can include, but is not limited to, a tree skidder, a tree forwarder, and related tree transport devices.

FIG. 4 illustrates a schematic view of an embodiment of a sensor arrangement 100 for the tree feller-buncher 10a, 10b. The sensor arrangement 100 provides sensor data that is utilized by a cut tree information system 200 to improve or optimize logging operation efficiency.

Referring to FIG. 4, a plurality of inertial measurement sensors 104 are positioned at locations on the tree feller-buncher 10a, 10b. Each inertial measurement sensor 104 detects changes in the position and/or orientation of the attached component. More specifically, each inertial measurement sensor 104 detects changes in (or measures the position and/or orientation of) the attached component along three axes: an X-axis or roll, a Y-axis or yaw, and a Z-axis or pitch. The inertial measurement sensor 104 can have a sensor associated with each axis that is being measured, such as a gyroscope or an accelerometer. Each inertial measurement sensor 104 provides sensor data associated with the position of the attached component along the three measured axes with reference to a reference position. The reference position can include gravity or a preset location of the component being measured.

In the embodiment illustrated in FIG. 4, a separate inertial measurement sensor 104 is connected to the main boom 38, the stick boom 42, and the wrist adapter 50. In other embodiments, additional or fewer inertial measurement sensors 104 can be included. For example, in another embodiment an additional inertial measurement sensor 104 can be connected to the felling head 46. Each inertial measurement sensor 104 tracks the position of the connected component during operation of the tree feller-buncher 10a, 10b.

A plurality of pressure sensors 108 are also positioned at locations on the tree feller-buncher 10a, 10b. More specifically, a pressure sensor 108 is connected to each hydraulic cylinder 58 associated with the boom 30. The pressure sensors 108 detect when a load is applied to the boom 30 (i.e., when the felling head 46 grasps a cut tree). In other embodiments, any number of pressure sensors 108 may be positioned on the tree feller-buncher 10a, 10b to detect application of a load to the boom 30 (e.g., one pressure sensor 108 or two or more pressure sensors 108).

An arm detection sensor 112 is positioned on the felling head 46 to detect the position of each arm 54. The arm detection sensor 112 can be a pressure sensor, arm position sensor, or any other suitable sensor. Based on the position of each arm 54, the diameter of the tree in the arm is calculated. Based on the species of tree, the combination of tree diameter and tree weight can be used to calculate a tree height. Accordingly, based on the calculated tree diameter and calculated tree weight, a tree height can also be calculated.

Each of the sensors 104, 108, 112 is in communication with a computer processing system or controller 116, illustrated in FIG. 4 by broken lines. The communication can be wired, wireless, or any suitable system for communication (e.g., radio, cellular, BLUETOOTH, etc.).

The tree feller-buncher 10a, 10b also includes a Global Positioning System (GPS) receiver 120. In FIG. 4, the feller-buncher GPS receiver 120 is illustrated as positioned on the turntable 22, however in other embodiments the GPS receiver 120 can be positioned on any suitable location of the tree feller-buncher 10a, 10b (e.g., in the cab 26, etc.). The feller-buncher GPS receiver 120 is in communication with the controller 116. The feller-buncher controller 116 can also be in communication with the cut tree information system 200, which is discussed in additional detail below. The communication can be any suitable wireless system for communication (e.g., radio, cellular, BLUETOOTH, 802.11 Wireless Networking protocol, etc.). In other embodiments, the cut tree information system 200 can reside on and/or operate from the feller-buncher controller 116. The feller-buncher controller 116 is also in communication with the cab 26 through an operator interface (not shown) to provide information relating to the sensors 104, 108, 112, the feller-buncher GPS receiver 120, and/or the cut tree information system 200 to the operator.

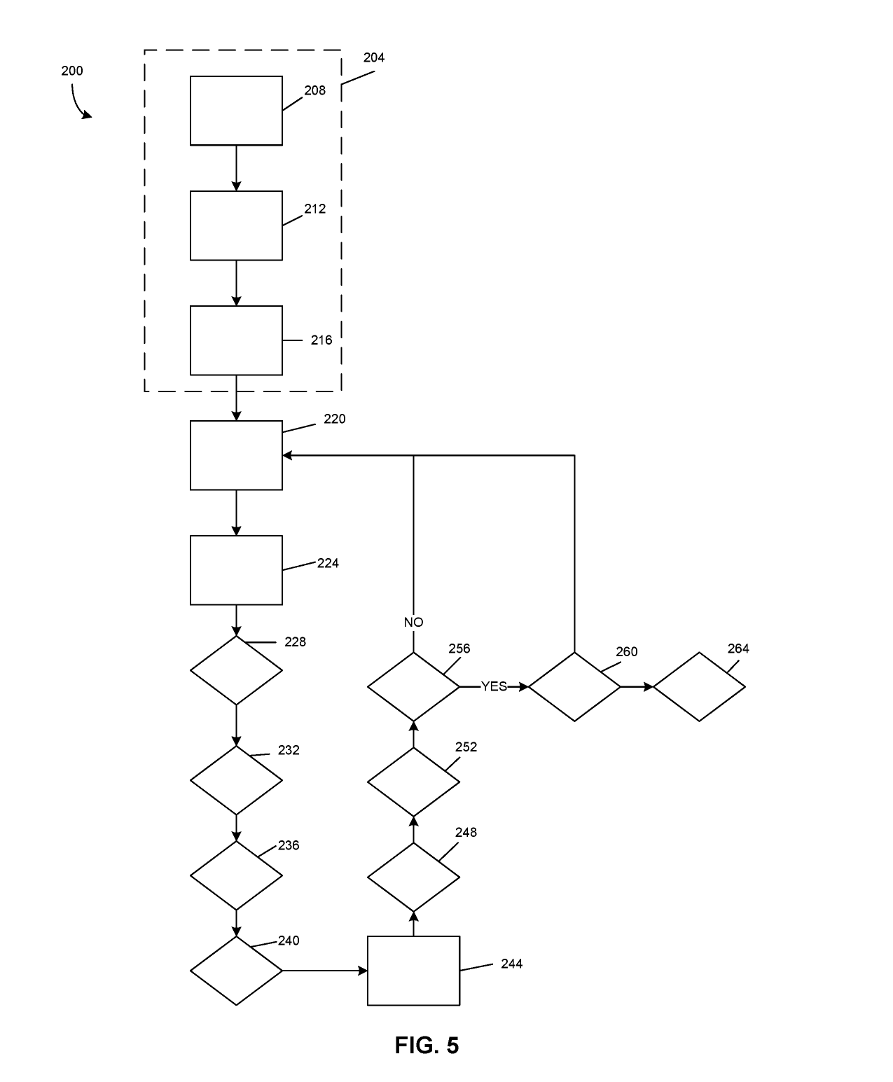

FIG. 5 illustrates an example of a cut tree information system or application 200 that uses information acquired from the tree feller-buncher 10a, 10b and the tree forwarder 80 to improve logging efficiency. More specifically, the cut tree information system 200 optimizes a felled tree pile size, such that the tree forwarder 80 will not require excessive return trips to transport each felled tree pile. The cut tree information system 200 also identifies and tracks locations of each felled tree pile, communicates the locations to the tree forwarder 80, and calculates an optimized path to each felled tree pile based on the location of the tree forwarder 80. By gathering and sharing this information between the tree feller-buncher 10a, 10b and the tree forwarder 80, logging efficiency is realized by reducing both the amount of time and the number of trips necessary for the tree forwarder 80 to move each felled tree pile to a location for transport.

The cut tree information system or application 200 can be a module that is distributed (i.e. operates on a remote server or from a remote location) and is in communication with one or more tree feller-buncher 10a, 10b and one or more tree forwarder 80. The communication can be through any suitable wireless connection, a web portal, a web site, a local area network, generally over the Internet, etc. In other embodiments, the system 200 can be an application or module that operates in a local environment. For example, the system 200 can be a module that operates on (or is associated with) the tree forwarder controller 92 (shown in FIG. 3), the feller-buncher controller 116 (shown in FIG. 4), and/or any other device in the vicinity of and in communication with the one or more tree feller-buncher 10a, 10b and the one or more tree forwarder 80 (e.g., a laptop computer, smartphone, etc.). The cut tree information system or application 200 includes a series of processing instructions or steps that are depicted in flow diagram form.

Referring to FIG. 5, the process begins at step 204, which is a logging job setup. During the logging job setup, a user, operator, or other individual inputs information associated with the logging equipment and the tree species subject to logging. In addition, other information can be input, such as the date, logging location, a custom logging or job identification information, etc. At step 208, the job setup 204 requests the capacity of tree feller-buncher 10a, 10b used in the logging job. For example, the capacity can include the capacity of each felling head 46 used with an associated tree feller-buncher 10a, 10b. Next, at step 212, the job setup 204 requests the capacity of each tree forwarder 80 used in the logging job. For example, the capacity can include the capacity of each grapple 84 used with an associated tree forwarder 80. At step 216, the job setup 204 can request one or more tree species subject to logging. Identification of the tree species streamlines calculations by the process 200, as stands of single species or blended (multiple) species can have affect the accuracy of calculations discussed in additional detail below (e.g., different wood species have different densities, different average height to weight ratios, etc.). After completion of the job setup 204, the process proceeds to step 220.

At step 220, the logging job begins, and the process is awaiting the tree feller-buncher 10a, 10b to engage and cut down a tree. Stated another way, the process detects whether the felling head 46 has an active load (i.e., whether the felling head 46 is carrying a cut or felled tree). To detect whether the felling head 46 has an active load, the process can detect a change in weight of the boom 30 by receiving data from the one or more pressure sensors 108 associated with the hydraulic cylinders 58, and then analyzing that data with reference to a set point (such as the data emitted by the pressure sensor 108 when the boom 30 does not have a load (i.e., an unloaded, steady state pressure sensor 108 output)). The set point can be a preprogrammed or preset reading from the pressure sensor 108. Optionally or additionally, the process can detect whether the arms 54 of the felling head 46 have been repositioned, rotated, or provide an increase in pressure indicative of engagement with a tree through the arm detection sensor 112, and/or whether a saw connected to the felling head 46 has cycled to cut the tree. If the process does not detect an active load, the process continues to wait until an active load is detected. When the process does detect an active load, the process proceeds to step 224.

At step 224, the process proceeds to communicate with the arm detection sensor 112 to acquire the position of the arms 54 of the felling head 46 to calculate a tree diameter. The position of the arms 54 can be pressure data emitted from the arm detection sensor 112, an actual arm 54 position in relation to the felling head 46 (i.e., data indicative of rotation of the arms 54 about the felling head 46), or any other data suitable to detect the position of the arms 54. At step 228, the process calculates a diameter of the tree in the felling head 46. More specifically, the arm detection sensor 112 provides measured data indicating a position of the arms 54. Based on the arm 54 position data, the process calculates an estimated tree diameter (as the process can include preprogrammed distances between the arms 54 based on the position data of each arm 54). Once the tree diameter has been calculated, the process proceeds to step 232.

At step 232, the process calculates the weight of the tree in the felling head 46. To calculate the tree weight, the process receives data from the one or more pressure sensors 108 associated with the hydraulic cylinders 58. The process also acquires the position information of the boom 30 from one or more of the associated inertial measurement sensors 104 (e.g., the X, Y, and Z positions of the main boom 38, the stick boom 42, the felling head 46, the wrist adapter 50, etc.). The process uses the data from the pressure sensors 108 and the position information of the boom 30 to calculate an estimated load weight of the boom 30 and the tree. This calculated load weight is then compared against a preprogrammed or preset weight of the boom 30. The difference results in a calculated weight of the tree in the felling head 46.

Next, at step 236, the process calculates an estimated height of the tree in the felling head 46. The process utilizes the calculated diameter and the calculated weight of the tree, and calculates an estimated height based on the tree species entered or selected at step 216. The tree height calculation can be, for example, through one or more calculations customized by tree species, or by a preprogrammed lookup table that provides estimated tree heights based on diameter and weight.

Proceeding to step 240, the process utilizes the calculated diameter, calculated weight, and calculated height of the tree to calculate an estimated tree volume. Next, at step 244 the process detects when the tree feller-buncher 10a, 10b places the felled tree in a pile (e.g., the felling head 46 releases the felled tree). For example, the process can detect when the arms 54 of the felling head 46 move or are repositioned to indicate a release of the tree through the arm detection sensor 112. As another example, the process can detect a change in the load of the felling head 46 by the pressure sensor 108. In addition, or optionally, the process can calculate an orientation of the felled tree. The orientation of the felled tree can be calculated by detecting an orientation or position information of the felling head 46 and/or the boom 30 from one or more of the associated inertial measurement sensors 104 (e.g., the X, Y, and Z positions of the main boom 38, the stick boom 42, the felling head 46, the wrist adapter 50, etc.). When the process detects a change in the load of the felling head 46 and/or calculates an orientation of the felled tree, the process proceeds to step 248.

At step 248, the process calculates a location of the cut tree and the associated pile that the cut tree is located. The process uses location data from the tree feller-buncher GPS receiver 120 and the position information of the boom 30 from one or more of the associated inertial measurement sensors 104 (e.g., the X, Y, and Z positions of the main boom 38, the stick boom 42, the felling head 46, the wrist adapter 50, etc.) to determine the exact location of the pile of cut trees. In some embodiments, the process can also communicate with the tree feller-buncher 10a, 10b (or the associated operator) to provide instructions as to the desired or targeted orientation of the felled trees on the pile during pile building based on the location data. For example, the process can provide visible instructions (e.g., on a screen, etc.) and/or audible instructions (e.g., verbal commands, a warnings sound, etc.) to the operator regarding a desired felled tree orientation. Managing felled tree orientation can provide interactive planning for pile building, as felled trees having a certain orientation (e.g., a same orientation with stumps oriented in the same direction, an alternating orientation with stumps oriented in alternating directions, etc.) in the pile, and/or a certain orientation with respect to an access point of the forwarder 80 (e.g., the pile is oriented to minimize forwarder 80 travel distance, maneuvering of the forwarder 80 that is necessary to remove the pile, etc.) can improve the efficiency of pile removal.

At step 252, the pile location, tree size information (calculated diameter, weight, height, and/or volume), and/or tree orientation is transmitted to a database or other information storage location. The database monitors the location of each pile and the calculated pile size (based on the tree size information).

Next, at step 256, the process determines if the pile size is such that it can be removed by one or more of the tree forwarder 80 based on the tree forwarder 80 capacity information entered in step 212. For example, the process may have a preprogrammed tolerance (e.g., within 90% of the maximum capacity of one trip of the tree forwarder 80, and more preferably within 95% of the maximum capacity of one trip of the tree forwarder 80, and more preferably between 90%-95% of the maximum capacity of one trip of the tree forwarder 80, and more preferably more than 90% but less than 99% of the maximum capacity of one trip of the tree forwarder 80, etc.), such that when the calculated pile size meets or exceeds, or is between the preprogrammed tolerance value or range, the process communicates with the tree feller-buncher 10a, 10b to instruct the operator to place no more trees on the pile. In addition, the process communicates with an associated tree forwarder 80 to instruct the operator to remove the pile. If the process determines that the pile size is such that it cannot be removed, or determines “no,” the process returns to step 220 and the logging process continues. If the process determines that the pile size such that it can be removed, or determines “yes,” the process proceeds to step 260.

At step 260, the process communicates with the tree feller-buncher 10a, 10b to instruct the operator to place no more trees on the pile, and to begin constructing a new pile of felled trees. Next, at step 264, the process identifies and selects the most appropriate tree forwarder 80 (e.g., based on location of the tree forwarder 80 to the finished pile, capacity of the tree forwarder 80 (e.g., grapple 84 capacity, loading space 86 capacity, etc.), identifies the location and/or orientation of the finished pile, acquires a location of the selected tree forwarder 80 based on location information acquired from the forwarder GPS receiver 94, and calculates an optimized path (or communicates an already calculated optimized path) for the selected tree forwarder 80 to travel from the tree forwarder's location to the finished pile. The optimized path can take into account a variety of variables, including access points, logging routes, travel distance, orientation of trees in the pile, and/or travel time. Once the optimized path is calculated, the process communicates with the selected tree forwarder 80 to communicate the location of the completed pile, the optimized path to travel to the completed pile, and any other suitable information (e.g., pile size or volume, etc.). The system then monitors the selected tree forwarder 80 to verify travel of the selected tree forwarder 80 to the completed pile and/or an until receipt of an acknowledgment from the operator of the selected tree forwarder 80 that the completed pile has been removed.

The process and system disclosed herein has certain advantages. For example, by collecting location and volume data on felled trees and the associated felled tree piles, the system can calculate a forest status (e.g., a percentage of harvested trees). This data can further be used in association with mapping information (e.g., LIDAR, satellite images, GPS, etc.) to develop a map illustrating a shape and location of felled trees and felled tree piles. One or more interested parties (e.g., landowners, lumber mills, tree harvesting companies, contractors, etc.) can understand a tree quantity and/or a tree volume at a particular site that has been harvested and/or that has yet to be harvested. These interested parties can also monitor tree felling progress and/or felling efficiency.

As another example, the interested parties can also have improved inventory management, as felled pile volume and location will be known, even in situations where trees are felled at one moment in time, and subsequently removed at another moment in time (e.g., one or more days later, one or more months later, one or more years later, etc.). This is further advantageous in some locations where felled piles cannot be visually confirmed at certain times of the year (e.g., in northern climates where snow can cover the felled piles for periods of time, etc.). One or more of the interested parties can plan equipment and resources to remove these felled piles (e.g., number of forwarders 80, size of each forwarder 80 loading space 86, size of each grapple 84, number and/or size of trucks needed once felled trees are delivered by forwarder 80, etc.), while also planning, developing, and/or generating access routes for an associated forwarder 80 to the felled pile even when the piles cannot be visually confirmed at the time of planning.

As another example, the improved inventory management also allows for improved planning by a purchaser or user of felled trees (e.g., lumber mill, saw mill, pulp mill, etc.) as the system provides felled tree size and/or volume information that has been delivered to the purchaser or user, and/or that remains in piles but is not delivered to the purchaser or user (e.g., work in progress or “WIP”). This allows a purchaser or user to better understand their wood supply chain, and react accordingly to avoid over purchase and/or under purchase. Over purchase can cause wood loss due to rotting or other non-use related issues, while under purchase can cause a purchaser or user to not have enough wood for their desired purpose. This information removes an amount of “guesswork” from the wood supply chain. This information also provides for payment of work completed (e.g., felling, skidding, processing at a road side, transport, etc.).

As another example, the process and system can provide for monitoring and improvement of felling efficiency. By tracking felled tree volume, along with one or more parameters of the felling and/or felled tree removal/skidding equipment (e.g., tree feller-buncher 10a, 10b, tree forwarder 80, etc.), process efficiency, equipment health, predictive equipment failure, and/or feedback for improved site planning can be developed. As a more specific, non-limiting example, by tracking fuel consumption (or fuel burn) for the felling and/or skidding equipment at a given location, and comparing it with the volume of felled trees, a fuel burn per volume felled can be calculated (e.g., gallons of fuel per cubic meter (or cubic foot) of tree felled). By tracking this data, process efficiency can be monitored (e.g., fuel consumption per volume of wood felled), felling and/or skidding equipment health can be monitored (e.g., if a feller begins to consume more fuel per volume of tree felled, it can indicate an equipment failure, etc.) to provide a measure of predictive equipment failure, and/or planning for felling at a given site can be performed (e.g., if a site has terrain that consumes more fuel during felling and/or skidding, those felling can plan for the additional fuel needed.

Various additional features and advantages of the disclosure are set forth herein.

What is claimed is:

1. A logging information system comprising:
a felling machine that includes a first global positioning system receiver and a sensor configured to measure an orientation of a felling head operably connected to the felling machine; and
an information system controller operable to estimate a cut tree location based on a measured global position of the felling machine and a measured orientation of the felling head of the felling machine.

2. The logging information system of claim 1, further comprising:
a tree transport machine, the information system controller operable to communicate the estimated cut tree location to the tree transport machine.

3. The logging information system of claim 2, wherein the tree transport machine includes a second global positioning system receiver, the information system controller operable to estimate an optimized route from a location of the tree transport machine based on the position from the second global positioning system receiver to the estimated cut tree location.

4. The logging information system of claim 3, the information system controller operable to communicate the optimized route to the tree transport machine.

5. The logging information system of claim 3, wherein the tree transport machine is one of a skidder or a forwarder.

6. The logging information system of claim 4, wherein the tree transport machine is a plurality of tree transport machines, wherein the second global positioning system receiver is a plurality of second global positioning system receivers, and wherein the information system controller is operable to select one of the tree transport machines, estimate an optimized route for the selected tree transport machine based at least in part on each of the location of the selected tree transport machine, the position of the second global positioning system receiver, and the estimated cut tree location.

7. The logging information system of claim 1, the information system controller operable to estimate a cut tree pile location based on a repeated measured global position of the felling machine and the measured orientation of the felling head of the felling machine.

8. The logging information system of claim 7, the felling machine further comprising:
an arm position detection sensor configured to measure a position of a plurality of arms coupled to the felling head, the plurality of arms configured to engage the cut tree;
a hydraulic cylinder operably connected to the felling head;
a pressure sensor configured to measure a pressure within at least one hydraulic cylinder; and
a controller operable to estimate a diameter of the cut tree engaged in the plurality of arms based on the measured position of the plurality of arms.

9. The logging information system of claim 8, wherein the controller is further operable to detect the cut tree in the felling head and estimate a weight of the cut tree in the felling head based on the measured pressure.

10. The logging information system of claim 9, wherein the controller is configured to estimate a height of the cut tree based in part on the calculated diameter of the cut tree and the calculated weight of the cut tree.

11. The logging information system of claim 10, the controller is configured to estimate a volume of the cut tree based in part on the calculated diameter of the cut tree, the calculated weight of the cut tree, and the calculated height of the cut tree.

12. The logging information system of claim 11, wherein the controller is configured to calculate an orientation of the cut tree based in part on the position of the felling head, calculated diameter of the cut tree, the calculated weight of the cut tree, and the calculated height of the cut tree.

13. The logging information system of claim 12, the information system controller is operable to store the estimated cut tree location and one of the calculated volume of the cut tree, the calculated diameter of the cut tree, the calculated weight of the cut tree, the calculated height of the cut tree, and/or the calculated orientation of the cut tree.

14. The logging information system of claim 13, the information system controller operable to calculate a cut tree pile size based in part on one of the calculated volume of the cut tree, the calculated diameter of the cut tree, the calculated weight of the cut tree, and the calculated height of the cut tree.

15. The logging information system of claim 14, the information system controller operable to communicate with the felling machine a cut tree pile location when the calculated cut tree pile size meets or exceeds an estimated tree transport machine capacity.

16. The logging information system of claim 8, wherein the tree transport machine includes a second global positioning system receiver, the information system controller operable to estimate an optimized route from a location of the forwarder machine based on the position from the second global positioning system receiver to the estimated cut tree pile location.

17. The logging information system of claim 15, wherein the tree transport machine is one of a skidder or a forwarder.

18. The logging information system of claim 15, wherein the tree transport machine is a plurality of tree transport machines, and each of the plurality of tree transport machines include a respective second global positioning system receiver, the wherein the information system controller is operable to select one of the tree transport machines, estimate an optimized route for the selected tree transport machine based at least in part on each of the location of the selected tree transport machine, the position of the second global positioning system receiver, and the estimated cut tree location.
